(19) United States
(12) Patent Application Publication
(10) Pub. No.: US 2004/0196943 A1
(43) Pub. Date: Oct. 7, 2004

(54) Process and apparatus for the production of clean nuclear energy

(76) Inventor: Umberto Di Caprio, Milano (IT)

Correspondence Address: MUSERLIAN AND LUCAS AND MERCANTI, LLP, 475 PARK AVENUE SOUTH, NEW YORK, NY, 10016, US

(21) Appl. No.: 10/481,174

(22) PCT Filed: Jun. 25, 2001
(86) PCT No.: PCT/IT01/00328

(51) Int. Cl. G21G 1/10

(52) U.S. Cl. 376/190

(57) ABSTRACT

Light atomic nuclei, such as deuterium, helium, lithium, carbon are subjected to radiance by means of charged subnuclear particles (electrons, protons or positrons) that are generated and accelerated by a preferably linear reactor. The particles (for instance protons and neutrons) released by the resulting fission are conditioned for the triggering of a nuclear chain reaction, whose energy that is produced free from noxious radiations is exploited to operate thermal machines and/or to produce electric energy.

The present invention relates to the field of nuclear energy and in particular to a kind of nuclear reaction so-called “clean”, i.e. not producing noxious radiations or radioactive waste.

It is known that the presently used nuclear reactors utilize mainly the fission reaction of U₂₃₅ which is present in naturally occurring uranium in the amount of 0.7%, and is mainly formed by U₂₃₈. Accordingly less than 1% of natural uranium is available. for a chain reaction.

It is known in addition that the fission of uranium, in itself weakly radioactive, results in the formation of by-products that are strongly radioactive, which comes to be a steady threat to the public health, with the resulting necessity of suitably shielding the whole reactor and disposing the dangerous waste in a manner that becomes more and more difficult to carry out. All these restrictive conditions check the further building of nuclear power stations.

On the other side, the increasing demand for power, as obliged by the presently prevailing industrial world, has incited the searchers to find out alternative power sources. They are thus since long trying to exploit, besides the so-called renewable sources (such as wind-borne, photovoltaic, geothermal, and so on), the nuclear fusion process like the one occurring in the stars. These attempts have however failed so far in obtaining practical results, owing to the remarkable difficulties in putting in practice the required functional conditions.

The applicant of the present invention has therefore resolved upon conceiving and putting in practice a novel application way of the nuclear fission by using as targets light atoms, namely atoms of elements with atomic number between 2 and 9. As a matter of fact, recent theoretical and conceptual developments prove that it is possible to get out nuclear energy even from “light” nuclei, such as helium, deuterium, lithium and carbon.

The reason why the fission of nuclei other than uranium, further actinides and lanthanides, was not so far taken into account is to be found in a deep-rooted prejudice based on the belief that the force holding together protons and neutrons in the atomic nucleus has not electrical nature only. A novel theory proposed by the present inventor demonstrates on the contrary that nuclear and subnuclear forces are of electromagnetic nature and that the nucleus is balanced by centrifugal forces due to the rotation of fitting particles.

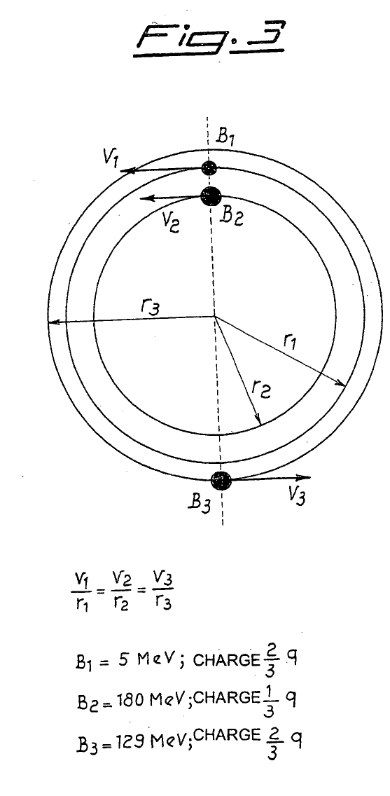

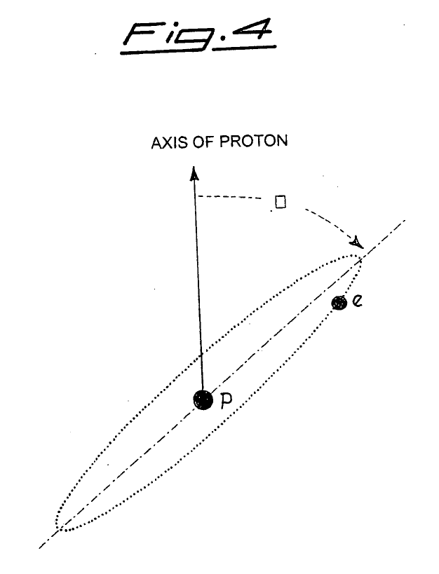

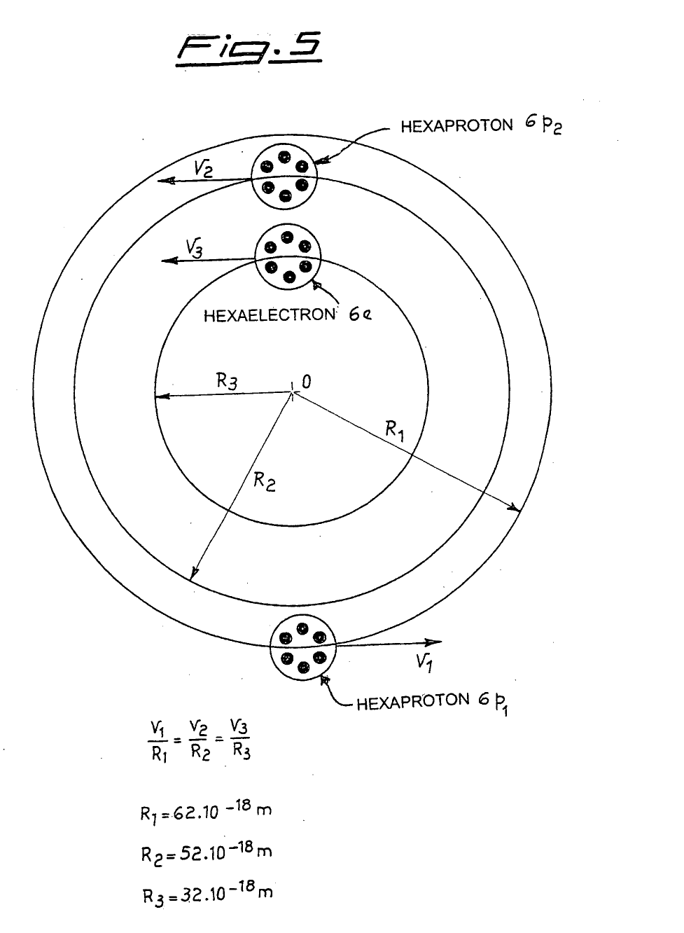

The breaking down of the nucleus causes the release of protons having high kinetic energy. Scientific contributions in this sense, as published in Hadronic Journal in December 1999 (U. Di Caprio and G. Spavieri “A new formula for the computation of spectra of complex atoms”) and in December 2000 (U. Di Caprio “The effects of the proton's magnetic field upon quantization”), as well as other works to be published, explain, among other things, a proton's dynamic model in the form of three mutually rotating quarks (as shown in FIG. 3 of this invention) as well as a neutron's one in the form of an electron rotating round a proton (as shown in FIG. 4). For the more complex structure of the carbon's nucleus, the presence of so-called “superprotons” has been assumed (as represented in FIG. 5).

The experimental results demonstrate that this new theory is valid without preclusions and that the nuclear energy can be produced in a safe and “clean” manner by the fission of light atoms.

Since to break up an atom of helium an energy of about 179 MeV is required, while the fission fragments release an energy of about 550 MeV, one can say that the output is 2.4 times. Similarly, the fission of a lithium atom involves an expenditure of about 714 MeV, while the relevant fragments release 1539 MeV (output=2.4), and the fission of a carbon atom requires 1480 MeV, while the energy released by the fragments is 3479 MeV with an output of about 2.35.

In order to start the chain reaction using carbon, that is by far the preferable element thanks to its easy availability, low costs and solid physical form, a resonating linear accelerator is used of the type LINAC having a length able to produce an energy of at least 2 GeV, for example about 250 m. The particles issued by accelerator strike the carbon mass in the form of graphite, which rather than act as a moderator like in today's nuclear power stations, forms itself the reactor active core according to the present invention. To control the chain reaction once started it is enough to use the known moderating metal (cadmium) bars which are able to absorb protons.

The invention will be better understood by considering the attached drawings, wherein:

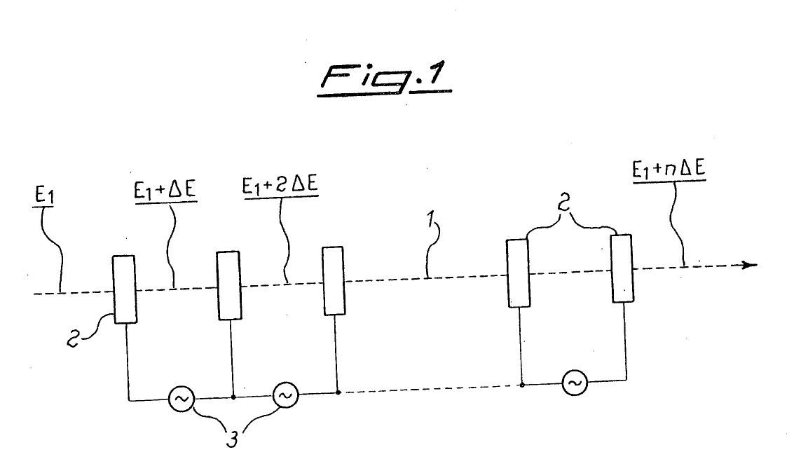

FIG. 1 represents the concept scheme of a linear resonating accelerator;

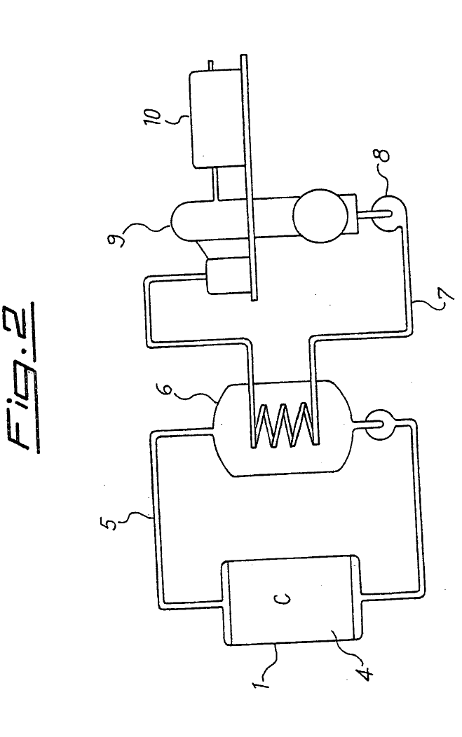

FIG. 2 shows the scheme of a plant for producing electric energy by means of a nuclear reactor using carbon;

FIG. 3 illustrates schematically the planar structure of proton;

FIG. 4 shows schematically the structure of neutron in the form of an electron rotating around a proton; and

FIG. 5 shows a simplified scheme for the structure of carbon nucleus.

As shown in FIG. 1, a straightforward beam 1 of subatomic particles issued by a suitable source is directed towards a series of guiding and accelerating tubes 2 that are fed through electromagnetic fields E+nΔE with increasing power generated by alternators 3. The particles flowing out from the accelerator at a maximum speed collide with the nuclei of the target substance 4 (FIG. 2) and trigger the chain reaction involving the progressive fission of the existing nuclei and release of the energy originating therefrom. The thus obtained thermal energy that is conveyed in a known manner by a gas 5 heats up to the boiling point through a heat exchanger 6, a fluid 7 (water) circulated by a pump 8, whose vapor feeds a turbine 9 that is connected to a generator 10 converting the thermal energy into electric energy.

### EXAMPLE

A mass of 1 Kg of ultrapure graphite was treated with a collimated beam of protons accelerated by a linear resonating accelerator having an energy of 2.15 GeV, and the resulting nuclear divergent chain reaction was controlled and moderated by inserting cadmium bars. The thermal energy generated by the nuclear reaction is theoretically equal to 239·10¹² Kcal/h; the practically exploitable thermal energy in an industrial power plant will be a part of the theoretical one owing to the limits that are inherent in the mechanical features of presently usable materials.

Said thermal energy will be picked up and conveyed for the practical exploitation through a heat exchanger and a hydraulic circuit.

Although the present invention has been described and illustrated on the basis of a preferred embodiment, it is clear that changes known to skilled persons may be introduced therein without departing from its spirit and leaving the protection scope as exposed in the appended claims. It will thus be possible to use a circular resonating accelerator instead of a linear one, and to act on liquid sooner than solid target masses.

1. A process for producing electric energy by means of nuclear fission through a controlled chain reaction, characterized in that the fission is carried out on masses of atoms (4) having atomic numbers from 1 to 9 and mass numbers from 2 to 19 by irradiating them with accelerated charged subatomic particles (1) such as to cause a release of energy equal to at least 1.48 Ge V.

2. The process according to claim 1, characterized in that said atoms having atomic numbers from 1 to 9 and mass numbers from 2 to 19 are selected from the group consisting of deuterium, helium, lithium, beryllium, boron, carbon, nitrogen, oxygen and fluorine.

3. The process of claim 2, wherein the atoms are carbon atoms, in particular in the form of graphite, (4) and said subatomic particles are protons (1)
